(19) United States
(12) Patent Application Publication
(10) Pub. No.: US 2017/0002175 A1
(43) Pub. Date: Jan. 5, 2017

(54) COPOLYESTER COMPOSITION FOR FORMING A TEMPERATURE-REGULATING COMPONENT OF A COMPOSITE FIBER AND THE COMPOSITE FIBER THUS MADE

(71) Applicant: Far Eastern New Century Corporation, Taipei City (TW)

(72) Inventors: Chun-Chia HSU, Taipei City (TW); Roy WU, Taipei City (TW); Li-Ling CHANG, Taipei City (TW); Shu-Chuan LEE, Taipei City (TW); Wei-Ling TSAO, Taipei City (TW)

(73) Assignee: Far Eastern New Century Corporation, Taipei City (TW)

(21) Appl. No.: 15/179,398

(22) Filed: Jun. 10, 2016

(30) Foreign Application Priority Data
Jun. 30, 2015 (TW) 104121136

(51) Int. Cl. C08K 5/101; C08K 5/09; C08K 5/098; C08K 3/34

(52) U.S. Cl. CPC C08K 5/101; C08K 3/34; C08K 5/09; C08K 5/098

(57) ABSTRACT

A copolyester composition includes a copolyester, an inorganic additive, and an aliphatic organic additive. The copolyester includes a hard segment including polybutylene terephthalate, and a soft segment including polyethylene gylcol and having a weight average molecular weight ranging from 2500 to 10000. The aliphatic organic additive has a melting point between a crystallization temperature of the hard segment and a melting point of the soft segment, and has a molecular weight not larger than 1000. The inorganic additive is in an amount ranging from 0.02 to 1.00 part by weight and the aliphatic organic additive is in an amount ranging from 0.02 to 1.00 part by weight.

### CROSS-REFERENCE TO RELATED APPLICATION

This application claims priority of Taiwanese Application No. 104121136, filed on Jun. 30, 2015.

### FIELD

The disclosure relates to a copolyester composition, and more particularly to a copolyester composition for forming a temperature-regulating component of a composite fiber. The disclosure also relates to the composite fiber thus made.

### BACKGROUND

With the fast development of textile technology, there are various kinds of functional fabric on the market. Specifically, developing fabrics having high strength and a bidirectional temperature-regulating function has been a trend in the textile industry.

CN 102505179A discloses a method for preparing thermal-storage and temperature-regulation fibers, in which a temperature-regulating monomer (polyethylene glycol acrylate) is grafted onto a fiber-forming polymer matrix through reactive extrusion during a spinning process. However, the amount of the temperature-regulating monomer grafted onto the fiber-forming polymer matrix may not be effectively increased. Therefore, the temperature-regulating effect of the fibers thus prepared is unsatisfactory.

It is disclosed in Acta Polymerica, vol. 41, p 31-36, 1990 that a copolymer composed of polybutylene terephthalate (PBT) and polyethylene glycol (PEG) is used as a material for producing fibers. The strength of the fibers is enhanced by increasing the spinning rate during the spinning process. However, the fibers thus produced do not have a temperature-regulating effect. In addition, when the amount of PEG in the copolymer is greater than 34 wt % based on 100 wt % of the copolymer, the strength of the fibers may not be effectively enhanced.

U.S. Pat. No. 4,401,792 discloses a process for increasing the rate of crystallization of polyester compounds by incorporating therein a small amount of a polyethylene ionomer or an alkali metal salt of benzoic acid, such as sodium benzoate. However, it does not mention how enthalpy can be raised to enhance the temperature-regulating effect.

China Synthetic Fiber Industry, vol. 27(2), p 25-26, 2004 discloses a method for increasing the strength of fibers formed from PBT-PEG copolyester into which polypropylene (PP) as a crystallization nucleating agent is added. However, due to the facts that the molecular weight of PP is too high and that PBT-PEG copolyester and PP cannot be uniformly mixed after compounding, an effective nucleating surface cannot be provided for PBT segments under high temperature, and the strength of the fibers may not be effectively enhanced.

CN 1051115C discloses a core-sheath fiber which has a bidirectional temperature-regulating function and in which a thermoplastic polymer having a low melting temperature (20 to 40° C.) is used as a temperature-regulating material. In order to achieve better temperature regulation, the temperature-regulating material may include an overheating melt preventing agent and/or a super-cooling crystallization preventing agent to prevent the temperature-regulating material from overheating melt and/or super-cooling crystallization. However, for some of the types of the overheating melt preventing agent and the super-cooling crystallization preventing agent and their added amounts disclosed in CN 1051115C, it has been found from experiments that they could not effectively enhance the bidirectional temperature-regulation ability of the fiber (e.g., adding a single type of the overheating melt preventing agent and/or the super-cooling crystallization preventing agent, or adding the overheating melt preventing agent and/or the super-cooling crystallization preventing agent containing a phenyl group).

There is a need in the art to provide a copolyester composition for forming a temperature-regulating component of a composite fiber so as to provide the composite fiber thus produced with enhanced strength and a bidirectional temperature-regulating function.

### SUMMARY

Therefore, an object of the disclosure is to provide a copolyester composition for forming a temperature-regulating component of a composite fiber so as to effectively enhance the strength and bidirectional temperature-regulating function of the composite fiber thus produced.

Another object of the disclosure is to provide a composite fiber having enhanced strength and a bidirectional temperature-regulating function.

According to one aspect of the disclosure, there is provided a copolyester composition for forming a temperature-regulating component of a composite fiber. The copolyester composition includes:

a copolyester including a hard segment which includes polybutylene terephthalate, and a soft segment which includes polyethylene glycol and which has a weight average molecular weight ranging from 2500 to 10000;

an inorganic additive; and

an aliphatic organic additive which has a melting point between a crystallization temperature of the hard segment and a melting point of the soft segment, and which has a molecular weight not larger than 1000.

The inorganic additive is in an amount ranging from 0.02 to 1.00 part by weight and the aliphatic organic additive is in an amount ranging from 0.02 to 1.00 part by weight based on 100 parts by weight of the copolyester.

According to another aspect of the disclosure, there is provided a composite fiber which includes a temperature-regulating component made from the copolyester composition.

### DETAILED DESCRIPTION

A copolyester composition according to this disclosure for forming a temperature-regulating component of a composite fiber includes:

a copolyester including a hard segment which includes polybutylene terephthalate, and a soft segment which includes polyethylene glycol and which has a weight average molecular weight ranging from 2500 to 10000;

an inorganic additive; and

an aliphatic organic additive which has a melting point between a crystallization temperature of the hard segment and a melting point of the soft segment, and which has a molecular weight not larger than 1000.

The inorganic additive is in an amount ranging from 0.02 to 1.00 part by weight and the aliphatic organic additive is in an amount ranging from 0.02 to 1.00 part by weight based on 100 parts by weight of the copolyester.

In certain embodiments, the soft segment is in a ratio ranging from 30 wt % to 80 wt % based on 100 wt % of the copolyester.

In certain embodiments, the soft segment has a weight average molecular weight ranging from 3000 to 9000.

In certain embodiments, the soft segment has a weight average molecular weight ranging from 3400 to 8000

In certain embodiments, the aliphatic organic additive is selected from the group consisting of a C₁₃-C₂₈ linear aliphatic hydrocarbon, a C₁₃-C₂₈ linear aliphatic hydrocarbyl ester, a C₁₃-C₂₈ linear aliphatic acid, salts thereof, and combinations thereof.

In certain embodiments, the aliphatic organic additive is selected from the group consisting of stearic acid, a salt of stearic acid, tridecyl methacrylate, and combinations thereof.

In certain embodiments, the melting point of the aliphatic organic additive ranges from 50° C. to 168° C.

In certain embodiments, the melting point of the aliphatic organic additive ranges from 55° C. to 160° C.

In certain embodiments, the inorganic additive is selected from the group consisting of talc, mica, zinc oxide, calcium oxide, titanium dioxide, silicon dioxide, calcium carbonate, barium sulfate, magnesium oxide, and combinations thereof.

A composite fiber according to this disclosure comprises a temperature-regulating component made from the copolyester composition.

The beneficial effect of the disclosure is that: since the copolymer composition includes both an inorganic additive, and an aliphatic organic additive which has a melting point between a crystallization temperature of the hard segment and a melting point of the soft segment and which has a molecular weight not larger than 1000, the composite fiber which comprises a temperature-regulating component made from the copolyester composition has enhanced strength and bidirectional temperature regulation.

The principle underlying the aforesaid beneficial effect is explained below:

(1) In general, the crystallization mechanism of a copolyester including hard segments (mainly composed of PBT) and soft segments (acting as a temperature-regulating portion and mainly composed of PEG) is as follows: When the copolyester is gradually cooled from a molten state to a crystallization temperature of the hard segments, the hard segments randomly collide with each other through thermal fluctuation to form a stable crystal nucleus. When the hard segments have grown to form a crystal of a certain side, the soft segments are excluded from the crystallization area of the hard segments. Then, when the copolyester is continuously cooled from the crystallization temperature of the hard segments to the crystallization temperature of the soft segments, the soft segments begin to crystallize along the crystals of the hard segments.

In the disclosure, when the copolyester is gradually cooled from the molten state, the inorganic additive may act as a crystallization nucleating agent for the hard segment. At the same time, the aliphatic organic additive can bring about an intermolecular lubricating effect during the crystallization process of the hard segment so as to improve the crystallinity of the hard segment (i.e., to enhance the crystallization enthalpy of the hard segment), and to improve the strength of the composite fiber thus produced.

In addition, when the copolyester is continuously cooled to the crystallization temperature of the soft segment, the aliphatic organic additive crystallizes before cooling to the crystallization temperature of the soft segment. Therefore, the aliphatic organic additive may act as the crystallization nucleating agent of the soft segment so as to enhance the crystallinity of the soft segment (i.e., to enhance the melting enthalpy (i.e., phase-changing enthalpy) of the soft segment), and to decrease the difference between the melting temperature and the crystallization temperature of the soft segment, so that the bidirectional temperature regulation of the composite fiber made from the copolyester composition may be enhanced.

(2) Due to the fact that the aliphatic organic additive has a molecular weight not larger than 1000, the aliphatic organic additive may be relatively uniformly mixed with the copolyester, so as to cause an intermolecular lubricating effect during the crystallization process of the hard segment and to enhance the crystallinity of the hard segment (i.e., to enhance the crystallization enthalpy of the hard segment). Therefore, the strength of the composite fiber thus produced may be enhanced.

### Copolyester:

The copolyester in the disclosure includes a hard segment and a soft segment.

In certain embodiments, the soft segment is in a ratio ranging from 30 wt % to 80 wt % based on 100 wt % of the copolyester. When the ratio of the soft segment is less than 30 wt %, the temperature-regulating effect of the composite fiber thus obtained is unsatisfactory. When the ratio is greater than 80 wt %, the melting strength of the copolyester is relatively low and the copolyester composition is thus not easy to be formed into fiber in a spinning process.

In certain embodiments, the soft segment is in a ratio ranging from 45 wt % to 65 wt % based on 100 wt % of the copolyester.

In certain embodiments, the soft segment has a weight average molecular weight ranging from 2500 to 10000. When the weight average molecular weight of the soft segment is less than 2500, the melting point and the phase-changing temperature of the copolyester are relatively low, so that the temperature-regulating effect of the composite fiber thus made from the copolyester is unsatisfactory. When the weight average molecular weight of the soft segment is greater than 10,000, the melting point and the crystallization temperature of the soft segment are too high, the upper limit of the range of temperature regulation of the composite fiber thus made from the copolyester is too high, so that the composite fiber is not suitable for making a temperature-regulating fabric. In certain embodiments, the soft segment has a weight average molecular weight ranging from 3000 to 9000. In certain embodiments, the soft segment has a weight average molecular weight ranging from 3400 to 8000. In the following embodiments, the weight average molecular weight of the soft segment is 4000.

The hard segment includes polybutylene terephthalate (PBT). In certain embodiments, the hard segment includes polybutylene terephthalate and an additional polyester. Examples of the additional polyester include, but are not limited to, polyethylene terephthalate (PET) and polytrimethylene terephthalate (PTT). In the following embodiments, the hard segment includes polybutylene terephthalate.

The soft segment includes polyethylene glycol (PEG). In certain embodiments, the soft segment includes polyethylene glycol and an additional polyether. A not-limiting example of the additional polyether is polypropylene glycol (PPG). In the following embodiments, the soft segment includes polyethylene glycol.

In certain embodiments, the crystallization enthalpy of the hard segment is not less than 20 J/g, and the hard segment has a crystallization temperature ranging from 160 to 200° C.

In certain embodiments, the melting enthalpy of the soft segment is not less than 40 J/g, the soft segment has a melting temperature ranging from 20 to 50° C., and the difference between the crystallization temperature and the melting temperature of the soft segment is not greater than 20° C.

### Inorganic Additive:

In certain embodiments, the inorganic additive is selected from the group consisting of talc, mica, zinc oxide, calcium oxide, titanium dioxide, silicon dioxide, calcium carbonate, barium sulfate, magnesium oxide, and combinations thereof. In the following embodiments, the inorganic additive is talc or titanium dioxide.

The inorganic additive is in an amount ranging from 0.02 to 1.00 part by weight based on 100 parts by weight of the copolyester. When the amount of the inorganic additive is greater than 1.00 part by weight, the strength of the composite fiber formed from the copolyester composition is not enough and thus, the composite fiber is not easy to be formed in the spinning process.

### Aliphatic Organic Additive:

In certain embodiments, the aliphatic organic additive is selected from the group consisting of a C₁₃-C₂₈ linear aliphatic hydrocarbon, a C₁₃-C₂₈ linear aliphatic hydrocarbyl ester, a C₁₃-C₂₈ linear aliphatic acid, salts thereof, and combinations thereof. In certain embodiments, the aliphatic organic additive is selected from the group consisting of stearic acid and salts thereof, tridecyl methacrylate, and combinations thereof. In the following embodiments, the aliphatic organic additive is tridecyl methacrylate, stearic acid (St), manganese (II) stearate (MnSt), zinc stearate (ZnSt), or calcium stearate (CaSt).

In certain embodiments, the melting point of the aliphatic organic additive ranges from 50° C. to 168° C. In certain embodiments, the melting point of the aliphatic organic additive ranges from 55° C. to 160° C.

The aliphatic organic additive is in an amount ranging from 0.02 to 1.00 part by weight based on 100 parts by weight of the copolyester. When the amount of the inorganic additive is greater than 1.00 part by weight, smoke and odor may be produced during the spinning process for forming the composite fiber from the copolyester composition.

### Copolyester Composition for Forming a Temperature-Regulating Component of a Composite Fiber:

In certain embodiments, the copolyester composition can further contain additional additives. Examples of the additional additives include, but are not limited to, a dye, a UV absorbent, a flame retardant, a fluorescent brightener, a matting agent, an antistatic agent, and an antibacterial agent.

Composite Fiber Made from the Copolyester Composition:

Composite fiber including a temperature-regulating component made from the copolyester composition has high strength and a bidirectional temperature-regulating function.

Composite fiber of the disclosure may be any form of fiber. Examples of the form of fiber include, but are not limited to, sheath-core composite fiber and sea-island composite fiber.

In certain embodiments, the composite fiber is a sheath-core composite fiber, and the core of the sheath-core composite fiber is made from the composite fiber of the disclosure.

The composite fiber is composed of the copolyester composition of the disclosure and at least one additional fiber-forming component. Examples of the additional fiber-forming component useful to prepare the composite fiber include, but are not limited to, polyester, polyamide, polyolefin, and polyurethane.

The following examples are provided to illustrate the embodiments of the disclosure, and should not be construed as limiting the scope of the disclosure.

### Chemicals:

TABLE 1

| Chemical | Abbreviation | Source |
|---|---|---|
| Dimethyl terephthalate | DMT | Teijin Limited |
| 1,4-butanediol | BG | Dairen |
| | | Chemical |
| | | Corporation |
| Ethylene glycol | EG | Oriental Union |
| | | Chemical |
| | | Corporation |
| Polyethylene glycol 4000 | PEG4000 | En Hou Polymer |
| | | Chemical Ind. |
| | | Co., LTD. |
| Polyethylene glycol 2000 | PEG2000 | En Hou Polymer |
| | | Chemical Ind. |
| | | Co. |
| Polyethylene glycol 11000 | PEG11000 | En Hou Polymer |
| | | Chemical Ind. |
| | | Co. |
| Polytetramethylene ether | PTMEG2000 | Formosa Asahi |
| glycol 2000 | | Spandex |
| | | Co., Ltd |
| Titanium (IV) isopropoxide | TIP | Sigma-Aldrich |
| | | Corp. |
| Talc powder | Talc | Taiwan Jiadeli |
| | | Co., Ltd, trade |
| | | name: P2000 |
| Titanium dioxide | TiO2 | Dingxing |
| | | Industry Co., |
| | | Ltd., trade |
| | | name: TA300 |
| Nonanoic acid | — | TCI Co., Ltd |
| Tridecyl methacrylate | Acr14 | Acros |
| | | Chemicals Ltd. |
| Stearic acid | St | Acros |
| | | Chemicals Ltd. |
| Manganese stearate | MnSt | MP Biomedicals |
| | | Company |
| Zinc stearate | ZnSt | Coin Chemical |
| | | Industial Co., |
| | | Ltd. |
| Calcium stearate | CaSt | Showa Corp. |
| Sodium stearate | NaSt | Acros |
| | | Chemicals Ltd. |
| Lithium stearate | LiSt | Worldwide |
| | | Resin & Chem. |
| | | Ltd. |
| Polypropylene | PP | ExxonMobil |
| | | Co., Ltd., |
| | | trade name: |
| | | PP3295G1 |
| 2,6-di-tert-butyl-4-methyl- | BHT | Acros |
| phenol) | | Chemicals Ltd |
| Polyethylene terephthalate | PET | Far Eastern New |
| | | Century Corp. |

### <Relative Viscosity Test>

Test samples for Examples 1 to 16 and Comparative Examples 1 to 18 were subjected to a relative viscosity test. The relative viscosity test for each of the test samples was conducted by dissolving each of the test samples (0.1 g for each of the test samples) in a phenol/tetrachloroethane mixed solvent (3/2 (v/v), 25 ml) at 110° C., followed by cooling to 30° C. The relative viscosity of each of the test samples was measured using an Ubbelohde viscometer. It should be noted that, in general, a material suitable for forming fibers by melt spinning has a relative viscosity ranging from 2.6 to 3.5.

### Examples 1 to 16 (E1-E16)

### Preparation of Copolyester Composition for Forming a Temperature-Regulating Component of a Composite Fiber

Each of the copolyester compositions of Examples 1 to 16 was prepared through the following steps:

Step (1): 195.2 g of dimethyl terephthalate, 138.3 g of 1,4-butanediol, 285.0 g of polyethylene glycol, an inorganic additive, and an aliphatic organic additive were mixed in a batch reactor to form a reaction mixture.

Step (2): After complete melting and mixing at 155° C., an esterification reaction was carried out by adding 1000 ppm of titanium isopropoxide into the batch reactor until the distillate amount of methanol reached 73.13 g, thereby obtaining a polymer precursor.

Step (3): A polycondensation reaction of the polymer precursor obtained in step (2) with 1000 ppm of titanium isopropoxide was performed at 250° C. under vacuum until a relative viscosity ranging from 2.6 to 3.5 was measured, thereby obtaining a copolyester composition. The copolyester composition includes PBT-PEG copolyester. The amount of the soft segment which includes polyethylene glycol is 57 wt % based on the total weight of the copolyester composition.

The inorganic additives and the aliphatic organic additives, and the amounts (based on 100 parts by weight of PBT-PEG copolyester) and properties thereof, and the weight average molecular weights of PEGs used in Examples 1 to 16 for preparing the copolyester compositions are summarized in the following Table 2.

TABLE 2

| | Aliphatic organic additive | | | | Inorganic additive | | |
|---|---|---|---|---|---|---|---|
| | | Amount | Melting | | | Amount | Mw |
| | | (part by | point | | | (part by | of |
| Exs. | Type | weight) | (° C.) | Mw | Type | weight) | PEG |
| 1 | Acr14 | 0.116 | 59.8 | 268 | Talc | 0.084 | 4000 |
| 2 | St | 0.116 | 59.6 | 284 | Talc | 0.084 | 4000 |
| 3 | MnSt | 0.116 | 98.9 | 621 | Talc | 0.084 | 4000 |
| 4 | ZnSt | 0.116 | 123.1 | 632 | Talc | 0.084 | 4000 |
| 5 | CaSt | 0.116 | 155.0 | 607 | Talc | 0.084 | 4000 |
| 6 | St | 0.116 | 59.6 | 284 | Talc | 0.02 | 4000 |
| 7 | St | 0.116 | 59.6 | 284 | Talc | 0.5 | 4000 |
| 8 | St | 0.116 | 59.6 | 284 | Talc | 1.0 | 4000 |
| 9 | St | 0.02 | 59.6 | 284 | Talc | 0.084 | 4000 |
| 10 | St | 0.05 | 59.6 | 284 | Talc | 0.084 | 4000 |
| 11 | St | 0.2 | 59.6 | 284 | Talc | 0.084 | 4000 |
| 12 | St | 0.6 | 59.6 | 284 | Talc | 0.084 | 4000 |
| 13 | St | 1.0 | 59.6 | 284 | Talc | 0.084 | 4000 |
| 14 | St | 0.116 | 59.6 | 284 | Talc | 0.084 | 3400 |
| 15 | St | 0.116 | 59.6 | 284 | Talc | 0.084 | 6000 |
| 16 | St | 0.116 | 59.6 | 284 | Talc | 0.084 | 8000 |

### Comparative Examples 1 to 7 and 9 to 13 (CE1-CE7 and CE9-CE13)

Each of the copolyester compositions of Comparative Examples 1 to 7 and 9 to 13 was prepared according to the method of Examples 1 to 16, except that the types or amounts of the inorganic additives and the aliphatic organic additives and the weight average molecular weights of PGEs shown in Table 3 below were used. The amounts in Table 3 are based on 100 parts by weight of the PBT-PEG copolyester.

TABLE 3

| | Aliphatic organic additive | | | | Inorganic additive | | |
|---|---|---|---|---|---|---|---|
| | | Amount | Melting | | | Amount | Mw |
| Comp. | | (part by | point | | | (part by | of |
| Exs. | Type | weight) | (° C.) | Mw | Type | weight) | PEG |
| 1 | None | — | — | — | None | — | 4000 |
| 2 | None | — | — | — | Talc | 0.084 | 4000 |
| 3 | St | 0.116 | 59.6 | 284 | None | — | 4000 |
| 4 | ZnSt | 0.2 | 123.1 | 632 | None | — | 4000 |
| 5 | NaSt | 0.116 | 200.2 | 306 | Talc | 0.084 | 4000 |
| 6 | LiSt | 0.116 | 225.3 | 290 | Talc | 0.084 | 4000 |
| 7 | Nonanoic | 0.116 | 12.5 | 158 | Talc | 0.084 | 4000 |
| | acid | | | | | | |
| 8 | PP | 0.116 | 146.5 | 80~150k | Talc | 0.084 | 4000 |
| 9 | BHT | 0.116 | 70 | 220 | TiO2 | 0.084 | 4000 |
| 10 | St | 0.116 | 59.6 | 284 | Talc | 0.084 | 2000 |
| 11 | St | 0.116 | 59.6 | 284 | Talc | 0.084 | 11000 |
| 12 | St | 0.116 | 59.6 | 284 | Talc | 1.2 | 4000 |
| 13 | None | — | — | — | None | — | 2000 |

### Comparative Example 8 (CE8)

The copolyester composition of Comparative Example 8 was prepared according to the following steps. The types and the amounts of the inorganic additive and the aliphatic organic additive and the weight average molecular weight of PEG shown in Table 3 were used. The amounts shown in Table 3 are based on 100 parts by weight of the PBT-PEG copolyester.

Step (1): 195.2 g of dimethyl terephthalate, 138.3 g of 1,4-butanediol, 285.0 g of polyethylene glycol, and an inorganic additive were mixed to prepare a copolyester composition using the aforementioned method to form a PBT-PEG copolyester composition.

Step (2): the PBT-PEG copolyester composition and polypropylene (PP) were blended in a feed tank of a twin screw extruder, followed by extruding using a die and cutting into a plurality of pellets to obtain a copolymer composition.

### Comparative Example 14 (CE14)

The copolyester composition of Comparative Example 14 was prepared according to the method of Comparative Example 1, except that polyethylene glycol used in Comparative Example 1 was replaced with polytetramethylene ether glycol (PTMEG2000, Mw=2000).

### Comparative Examples 15 to 18 (CE15-CE18)

### PET-PEG Copolyester was Used

The copolyester compositions of Comparative Examples 15 to 18 were prepared according to the following steps. The types or the amounts of the inorganic additive and the aliphatic organic additive, and the weight average molecular weight of PEG shown in Table 4 below were used. The amounts shown in Table are based on 100 parts by weight of the PET-PEG copolyester.

Step (1): 221.6 g of dimethyl terephthalate, 108.8 g of 1,2-glycol, 285.0 g of polyethylene glycol, an inorganic additive (if used), and an aliphatic organic additive (if used) were mixed in a batch reactor to form a reaction mixture.

Step (2): After complete melting and mixing at 155° C., an esterification reaction was carried out by adding 1000 ppm of titanium isopropoxide into the batch reactor until the distillate amount of methanol reached 73.13 g, thereby obtaining a polymer precursor.

Step (3): A polycondensation of the polymer precursor obtained in step (2) with 1000 ppm of titanium isopropoxide was performed at 250° C. under vacuum until a relative viscosity ranging from 2.6 to 3.5 was measured, thereby obtaining a copolyester composition.

The copolyester composition includes PBT-PEG copolyester. The amount of the soft segment which includes polyethylene glycol is 57 wt % based on the total weight of the copolyester composition.

TABLE 4

| | Aliphatic organic additive | | | | Inorganic additive | | |
|---|---|---|---|---|---|---|---|
| | | Amount | Melting | | | Amount | Mw |
| Comp. | | (part by | point | | | (part by | of |
| Exs. | Type | weight) | (° C.) | Mw | Type | weight) | PEG |
| 15 | None | — | — | — | None | — | 4000 |
| 16 | None | — | — | — | Talc | 0.084 | 4000 |
| 17 | St | 0.116 | 59.6 | 284 | None | — | 4000 |
| 18 | St | 0.116 | 59.6 | 284 | Talc | 0.084 | 4000 |

### Application Example 1 (AE1)

### Preparation of a Composite Fiber Comprising a Temperature-Regulating Component Made from a Copolyester Composition

### (Core Layer: The Copolyester Composition of Example 2; Sheath Layer: PET)

The copolyester composition of Example 2 was put into an extruder of a melt-spinning machine, and PET (Rv=1.60 to 1.75) was put into another extruder of the melt-spinning machine. The copolyester composition of Example 2 and PET were spun to obtain a core-sheath composite fiber. The core layer of the composite fiber was made from the copolyester composition of Example 2, and the sheath layer was made from PET. The weight ratio of copolyester composition of Example 2 to PET was 1:1.

### Comparative Application Example 1 (CAE1)

### Core Layer: The Copolyester Composition of Comparative Example 1; Sheath Layer: PET

A composite fiber of Comparative Application Example 1 was prepared according to the method of Application Example 1, except that the core layer of the composite fiber was made from the copolyester composition of Comparative Example 1.

### Comparative Application Example 2 (CAE2)

### Core Layer: The Copolyester Composition of Comparative Example 12; Sheath Layer: PET

A composite fiber of Comparative Application Example 2 was prepared according to the method of Application Example 1, except that the core layer of the composite fiber was made from the copolyester composition of Comparative Example 12.

### Application Example 2 (AE2)

### Preparation of Nonwoven Fabric

The nonwoven fiber of Application Example 2 was made from the composite fiber of Application Example 1 and had a fabric weight of 500 g/m².

### Comparative Application Example 3 (CAE3)

The nonwoven fiber of Comparative Application Example 3 was made from the composite fiber of Comparative Application Example 1 and had a fabric weight of 500 g/m².

### <Tests of Thermal Properties>

### (a) Crystallization Temperatures (Tc) of the Hard and Soft Segments and Melting Temperature (Tm) of the Soft Segment:

The crystallization temperatures (Tc) of the hard and soft segments and the melting temperature (Tm) of the soft segment of each of the samples of the copolyester compositions, the composite fibers, and the nonwoven fabrics to be tested were measured using a differential scanning calorimeter (DSC, under a trade name of DSC2910) manufactured by TA Instrument.

The measurement was conducted according to the operation manual of the differential scanning calorimeter, and involved the following step: each of the test samples was measured at the heating rate of 10° C./min and the cooling rate of 10° C./min between −80 to 250° C., and the melting peak (i.e. melting temperature) of the soft segment and the crystallization peak (i.e. crystallization temperature) of the hard and soft segments were determined.

### (b) Melting Enthalpy of the Soft Segment and Crystallization Enthalpy of the Hard Segment:

Peak areas of the melting peak of the soft segment and the crystallization peak of the hard segment were calculated using integration to respectively obtain the melting enthalpy of the soft segment and the crystallization enthalpy of the hard segment.

### (c) Difference Between the Melting and Crystallization Temperatures of the Soft Segment (ΔT):

Difference between the melting and crystallization temperatures of the soft segment (ΔT) was calculated using the following formula:

ΔT (° C.)=the melting temperature of the soft segment−the crystallization temperature of the soft segment

### <Comparison and Discussion of the Thermal Properties of Examples 1 to 16 and Comparative Examples 1 to 18>

### (a) Thermal Properties of Examples 1 to 16

The thermal properties of the copolyester compositions of Examples 1 to 16 as measured according to the aforesaid tests are shown in Table 5 below.

TABLE 5

| | | | | | melting | crystallization |
|---|---|---|---|---|---|---|
| | Tc of | Tc of | Tm of | | enthalpy | enthalpy |
| | hard | soft | soft | | of soft | of hard |
| | segment | segment | segment | ΔT | segment | segment |
| Exs. | (° C.) | (° C.) | (° C.) | (° C.) | (J/g) | (J/g) |
| 1 | 184.0 | 20.1 | 39.0 | 18.9 | 47.3 | 25.8 |
| 2 | 184.5 | 19.5 | 38.9 | 19.4 | 48.5 | 27.8 |
| 3 | 184.3 | 20.2 | 38.8 | 18.6 | 47.2 | 26.5 |
| 4 | 184.6 | 19.2 | 38.8 | 19.6 | 48.6 | 26.9 |
| 5 | 182.9 | 19.5 | 38.8 | 19.3 | 47.2 | 25.7 |
| 6 | 182.6 | 19.4 | 38.3 | 18.9 | 47.0 | 25.3 |
| 7 | 184.4 | 19.5 | 38.2 | 18.7 | 48.5 | 27.7 |
| 8 | 184.1 | 19.3 | 38.0 | 18.7 | 47.9 | 26.2 |
| 9 | 182.4 | 18.7 | 38.1 | 19.4 | 41.8 | 24.1 |
| 10 | 183.6 | 18.6 | 38.3 | 19.7 | 43.0 | 26.5 |
| 11 | 184.4 | 19.2 | 38.2 | 19.0 | 46.1 | 27.8 |
| 12 | 183.8 | 19.4 | 38.3 | 18.9 | 42.8 | 27.3 |
| 13 | 183.1 | 18.9 | 38.4 | 19.5 | 41.0 | 27.6 |
| 14 | 168.4 | 11.4 | 30.1 | 18.7 | 40.1 | 26.5 |
| 15 | 193.4 | 24.4 | 44.3 | 19.9 | 53.0 | 26.9 |
| 16 | 194.5 | 33.0 | 49.3 | 16.3 | 66.5 | 27.7 |

As shown in Table 5, the melting temperatures of the soft segments (PEG) of the copolyesters included in the copolyester compositions of Examples 1 to 16 range from 20 to 50° C., the melting enthalpies of the soft segments are not less than 40 J/g, and the values of ΔT are less than 20° C. Furthermore, the crystallization enthalpies of the hard segments of the copolyesters included in the copolyester compositions of Examples 1 to 16 are not less than 24 J/g.

### (b) Comparison and Discussion of Examples 1 to 5 and 11 and Comparative Examples 1 to 4:

The thermal properties of the copolyester compositions of Comparative Examples 1 to 4 measured in the aforesaid tests are shown in Table 6 below.

TABLE 6

| | | | | | melting | crystallization |
|---|---|---|---|---|---|---|
| | Tc of | Tc of | Tm of | | enthalpy | enthalpy |
| | hard | soft | soft | | of soft | of hard |
| Comp. | segment | segment | segment | ΔT | segment | segment |
| Exs. | (° C.) | (° C.) | (° C.) | (° C.) | (J/g) | (J/g) |
| 1 | 169.0 | 15.3 | 38.6 | 23.3 | 36.8 | 15.3 |
| 2 | 182.7 | 19.1 | 38.6 | 19.5 | 36.3 | 15.7 |
| 3 | 168.7 | 16.6 | 38.8 | 22.2 | 35.4 | 15.5 |
| 4 | 169.1 | 16.8 | 38.8 | 22.0 | 34.7 | 14.9 |

As shown in Tables 5 and 6, for the copolyester composition of Comparative Example 1 which was free of the inorganic additive and the aliphatic organic additive, the copolyester composition of Comparative Example 2 which was free of the aliphatic organic additive, and the copolyester compositions of Comparative Examples 3 and 4 which were free of the inorganic additive, the crystallization enthalpies (less than 16 J/g) of the hard segments of the copolyesters included therein are significantly less than those of the hard segments of the copolyesters included in the copolyester compositions of Examples 1 to 5 and 11 (greater than 25 J/g). This demonstrates that the crystallinities of the hard segments (PBT) of the copolyesters included in the copolyester compositions of Comparative Examples 1 to 4 are less than those of the hard segments of the copolyesters included in the copolyester compositions of Examples 1 to 5 and 11, which indicates that the strength of the composite fibers produced from the copolyester compositions of Examples 1 to 5 and 11, in which both the inorganic additive and the aliphatic organic additive were included, are superior to the strength of the composite fibers produced from the copolyester compositions of Comparative Examples 1 to 4.

Furthermore, the melting enthalpies of the soft segments (PEG) of the copolyesters included in the copolyester compositions of Comparative Examples 1 to 4 (less than 37 J/g) are less than those of the soft segments of the copolyesters included in the copolyester compositions of Examples 1 to 5 and 11 (greater than 46 J/g), and the values of ΔT of Comparative Examples 1, 3 and 4 (greater than 20° C.) are greater than those of Examples 1 to 5 and 11 (less than 20° C.). This demonstrates that the bidirectional temperature-regulating effect of the composite fibers made from the copolyester compositions of Examples 1 to 5 and 11 are better than that of the composite fibers made from the copolyester compositions of Comparative Examples 1 to 4.

In view of the aforesaid, the strength and the bidirectional temperature-regulating effect of the composite fiber can be improved using a copolyester composition which includes an inorganic additive and an aliphatic organic additive of the disclosure.

### (c) Comparison and Discussion of Examples 1 to 5 and Comparative Examples 5 to 7

The thermal properties of the copolyester compositions of Comparative Examples 1 to 4 as measured according to the aforesaid tests are shown in Table 7.

TABLE 7

| | Mp of the | | | | | melting | crystallization |
|---|---|---|---|---|---|---|---|
| | aliphatic | Tc of | Tc of | Tm of | | enthalpy | enthalpy |
| | organic | hard | soft | soft | | of soft | of hard |
| | additive | segment | segment | segment | ΔT | segment | segment |
| | (° C.) | (° C.) | (° C.) | (° C.) | (° C.) | (J/g) | (J/g) |
| E1 | 59.8 | 184.0 | 20.1 | 39.0 | 18.9 | 47.3 | 25.8 |
| E2 | 59.6 | 184.5 | 19.5 | 38.9 | 19.4 | 48.5 | 27.8 |
| E3 | 98.9 | 184.3 | 20.2 | 38.8 | 18.6 | 47.2 | 26.5 |
| E4 | 123.1 | 184.6 | 19.2 | 38.8 | 19.6 | 48.6 | 26.9 |
| E5 | 155.0 | 182.9 | 19.5 | 38.8 | 19.3 | 47.2 | 25.7 |
| CE5 | 200.2 | 183.9 | 18.0 | 39.2 | 21.2 | 37.3 | 16.1 |
| CE6 | 225.3 | 183.1 | 17.7 | 38.8 | 21.1 | 36.9 | 15.8 |
| CE7 | 12.5 | 182.9 | 16.7 | 38.0 | 21.3 | 37.5 | 16.5 |

As shown in Table 7, each of the melting points of the aliphatic organic additives included in the copolyester compositions of Comparative Examples 5 to 7 is not between the crystallization temperature of the hard segment (PBT) and the melting temperature of the soft segment (PEG). Each of the melting points of the aliphatic organic additives included in the copolyester compositions of Examples 1 to 5 is between the crystallization temperature of the hard segment (PBT) and the melting temperature of soft segment (PEG). The crystallization enthalpies of the hard segments of the copolyesters included in the copolyester compositions of Comparative Examples 5 to 7 are less than 17 J/g, and those of the hard segments of the copolyesters included in the copolyester compositions of Examples 1 to 5 are greater than 25 J/g.

This demonstrates that the crystallinities of the hard segments (PBT) of the copolyesters included in the copolyester compositions of Comparative Examples 5 to 7 are less than those of the hard segments of the copolyesters included in the copolyester compositions of Examples 1 to 5, which indicates that the strength of the composite fibers made from the copolyester compositions of Examples 1 to 5 are superior to that of the composite fibers made from the copolyester compositions of Comparative Examples 5 and 7.

Furthermore, the melting enthalpies of the soft segments of the copolyesters included in the copolyester compositions of Comparative Examples 5 to (less than 38 J/g) are less than those of the soft segments of the copolyesters included in the copolyester compositions of Examples 1 to 5 (greater than 47 J/g), and the values of ΔT of Comparative Examples 5 to 7 (greater than 21° C.) are greater than those of Examples 1 to 5 (less than 20° C.). This demonstrates that the bidirectional temperature-regulating effect of the composite fibers made from the copolyester compositions of Examples 1 to 5 are better than that of the composite fibers made from the copolyester compositions of Comparative Examples 5 to 7.

In view of the aforesaid, the strength and the bidirectional temperature-regulating effect of the composite fiber can be improved using a copolyester composition which includes an aliphatic organic additive having a melting point between the crystallization temperature of a hard segment and the melting temperature of a soft segment.

### (d) Comparison and Discussion of Examples 1 to 5 and Comparative Example 8:

The thermal properties of the copolyester composition of Comparative Example 8 as measured using the aforesaid tests are shown in Table 8 below.

TABLE 8

| | | | | | | melting | crystallization |
|---|---|---|---|---|---|---|---|
| | Mw of the | Tc of | Tc of | Tm of | | enthalpy | enthalpy |
| | aliphatic | hard | soft | soft | | of soft | of hard |
| | organic | segment | segment | segment | ΔT | segment | segment |
| | additive | (° C.) | (° C.) | (° C.) | (° C.) | (J/g) | (J/g) |
| E1 | 268 | 184.0 | 20.1 | 39.0 | 18.9 | 47.3 | 25.8 |
| E2 | 284 | 184.5 | 19.5 | 38.9 | 19.4 | 48.5 | 27.8 |
| E3 | 621 | 184.3 | 20.2 | 38.8 | 18.6 | 47.2 | 26.5 |
| E4 | 632 | 184.6 | 19.2 | 38.8 | 19.6 | 48.6 | 26.9 |
| E5 | 607 | 182.9 | 19.5 | 38.8 | 19.3 | 47.2 | 25.7 |
| CE8 | 80000~150000 | 182.9 | 18.1 | 38.6 | 20.5 | 37.1 | 15.3 |

As shown in Table 8, the molecular weight of the aliphatic organic additive included in the copolyester composition of Comparative Example 8 is greater than 1000, and the molecular weights of the aliphatic organic additives included in the copolyester compositions of Examples 1 to 5 are less than 1000. The crystallization enthalpy of the hard segment of the copolymer included in the copolyester composition of Comparative Example 8 (15.3 J/g) is less than those of the hard segments of the copolymers included in the copolyester compositions of Examples 1 to 5 (greater than 25 J/g).

This demonstrates that the crystallinity of the hard segment (PBT) of the copolyester included in the copolyester composition of Comparative Example 8 is less than those of the hard segments of the copolyesters included in the copolyester compositions of Examples to 5, which indicates that the strength of the composite fibers made from the copolyester compositions of Examples 1 to 5 is superior to that of the composite fiber made from the copolyester composition of Comparative Example 8.

Furthermore, the melting enthalpy of the soft segment of the copolyester included in the copolyester composition of Comparative Example 8 (37.1 J/g) is less than those of the soft segments of the copolyesters included in the copolyester compositions of Examples 1 to 5 (greater than 47 J/g), and the value of ΔT of Comparative Example 8 (greater than 20° C.) is greater than those of Examples 1 to 5 (less than 20° C.), which demonstrates that the bidirectional temperature-regulating effect of the composite fibers made from the copolyester compositions of Examples 1 to 5 is better than that of the composite fiber made from the copolyester composition of Comparative Example 8.

In view of the aforesaid, the strength and the bidirectional temperature-regulating effect of the composite fiber can be improved using a copolyester composition which includes an aliphatic organic additive having a weight average molecular weight less than 1000.

### (e) Comparison and Discussion of Examples 1 to 16 and Comparative Example 9

The thermal properties of the copolyester composition of Comparative Example 9 as measured using the aforesaid tests are shown in Table 9 below.

TABLE 9

| | type of | | | | | | crystallization |
|---|---|---|---|---|---|---|---|
| | aliphatic | Tc of | Tc of | Tm of | | melting | enthalpy |
| | organic | hard | soft | soft | | enthalpy | of hard |
| | additive | segment | segment | segment | ΔT | of soft | segment |
| | (° C.) | (° C.) | (° C.) | ° C.) | (° C.) | segment(J/g) | (J/g) |
| CE9 | BHT | 177.1 | 17.7 | 38.0 | 20.3 | 37.4 | 15.5 |
| | (Phenyl | | | | | | |
| | group | | | | | | |
| | included) | | | | | | |

As shown in Tables 5 and 9, the crystallization enthalpy of the hard segment of the copolymer included in the copolyester composition of Comparative Example 9, in which the aliphatic organic additive including a phenyl group is used, is 15.5 J/g, and the crystallization enthalpy of the hard segment of the copolymer included in the copolyester composition of Examples 1 to 15 are not less than 24 J/g. This demonstrates that the crystallinity of the hard segment (PBT) of the copolymer included in the copolyester composition of Comparative Example 9 is less than those of the hard segments (PBT) of the copolymers included in the copolyester compositions of Examples 1 to 16, which indicates that the strength of the composite fibers made from the copolyester compositions of Examples 1 to 16 is superior to that of the composite fiber made from the copolyester composition of Comparative Example 9.

Furthermore, the melting enthalpy of the soft segment of the copolymer included in the copolyester composition of Comparative Example 9 (37.4 J/g) is less than those of the soft segments of the copolymers included in the copolyester compositions of Examples 1 to 16 (greater than 40 J/g), and the value of ΔT of Comparative Example 8 (greater than 20° C.) is greater than those of Examples 1 to 16 (less than 20° C.). This demonstrates that the bidirectional temperature-regulating effect of the composite fibers made from the copolyester compositions of Examples 1 to 16 is better than that of the composite fiber made from the copolyester composition of Comparative Example 9.

In view of the aforesaid, the strength and the bidirectional temperature-regulating effect of the composite fiber can be improved using a copolyester composition which includes an aliphatic organic additive free of phenyl group.

### (f) Comparison and Discussion of Examples 2 and 14 to 16 and Comparative Examples 10, 11, 13 and 14:

The thermal properties of the copolyester compositions of Comparative Examples 10, 11, 13 and 14 as measured using the aforesaid tests are shown in Table 10 below.

TABLE 10

| | | | | | | Melting | Crystallization |
|---|---|---|---|---|---|---|---|
| | | Tc of | Tc of | Tm of | | enthalpy | enthalpy |
| | Mw of | hard | soft | soft | | of soft | of hard |
| | soft | segment | segment | segment | ΔT | segment | segment |
| | segment | (° C.) | (° C.) | (° C.) | (° C.) | (J/g) | (J/g) |
| E2 | 4000 | 184.5 | 19.5 | 38.9 | 19.4 | 48.5 | 27.8 |
| | (PEG) | | | | | | |
| E14 | 3400 | 168.4 | 11.4 | 30.1 | 18.7 | 40.1 | 26.5 |
| | (PEG) | | | | | | |
| E15 | 6000 | 193.4 | 24.4 | 44.3 | 19.9 | 53.0 | 26.9 |
| | (PEG) | | | | | | |
| E16 | 8000 | 194.5 | 33.0 | 49.3 | 16.3 | 66.5 | 27.7 |
| | (PEG) | | | | | | |
| CE10 | 2000 | 169.8 | 5.2 | 26.8 | 21.6 | 33.7 | 25.9 |
| | (PEG) | | | | | | |
| CE11 | 11000 | 194.3 | 38.4 | 54.6 | 16.2 | 72.8 | 30.6 |
| | (PEG) | | | | | | |
| CE13 | 2000 | 139 | 0.0 | 23.8 | 23.8 | 26.3 | 17.2 |
| | (PEG) | | | | | | |
| CE14 | 2000 | 137 | −9.0 | 21.7 | 30.7 | 26.0 | 17.0 |
| | (PTMEG) | | | | | | |

As shown in Table 10, the melting enthalpy of the soft segment (PEG) of the copolyester of the copolyester composition of Comparative Example 10 is 33.7 J/g, in which the weight average molecular weight of the soft segment of the copolyester is less than 2500, and those of the soft segments of the copolyesters of the copolyester compositions of Examples 2 and 14 to 16 are not less than 40 J/g. Furthermore, the value of ΔT of Comparative Example 10 (greater than 21° C.) is greater than those of Examples 2 and 14 to 16 (less than 20° C.). This demonstrates that the bidirectional temperature-regulating effect of the composite fibers made from the copolyester compositions of Examples 2 and 14 to 16 is better than that of the composite fiber made from the copolyester composition of Comparative Example 10.

The soft segment of the copolyester of the copolyester composition of Comparative Example 11 has a weight average molecular weight greater than 10000 and a melting point greater than those of the soft segments of the copolyesters of the copolyester compositions of Examples 2 and 14 to 16. An upper limit of the range of temperature regulation of the composite fiber of Comparative Example 11 is too high, the composite fiber of Comparative Example 11 is not suitable for making a fabric.

In view of the aforesaid, the bidirectional temperature-regulating effect of the composite fiber can be improved using a copolyester composition in which a copolyester including a soft segment having a weight average molecular weight ranging from 2500 to 10000 is included.

It should be noted that the soft segment of the copolyester of the copolyester composition of Comparative Example 14 was PTMEG 2000 and the soft segment of the copolyester of the copolyester composition of Comparative Example 13 was PEG 2000. A comparison of Comparative Examples 13 and 14 shows that the longer the carbon chain of the soft segment, the greater the value of ΔT. This in turn results in an unsatisfactory bidirectional temperature-regulating effect of the composite fiber.

### (g) Comparison and Discussion of Example 2 and Comparative Examples 15 to 18:

The thermal properties of the copolyester compositions of Comparative Examples 15 to 18 as measured using the aforesaid tests are shown in Table 11 below.

TABLE 11

| | | | | | | Melting | Crystallization |
|---|---|---|---|---|---|---|---|
| | | Tc of | Tc of | Tm of | | enthalpy | enthalpy |
| | Type of | hard | soft | soft | | of soft | of hard |
| | hard | segment | segment | segment | ΔT | segment | segment |
| | segment | (° C.) | (° C.) | (° C.) | (° C.) | (J/g) | (J/g) |
| E2 | PBT | 184.5 | 19.5 | 38.9 | 19.4 | 48.5 | 27.8 |
| CE15 | PET | 165.9 | 15.5 | 38.5 | 23.0 | 40.7 | 14.6 |
| CE16 | PET | 161.2 | 14.1 | 37.3 | 23.2 | 37.9 | 13.3 |
| CE17 | PET | 150.9 | 9.9 | 36.5 | 26.6 | 38.0 | 14.6 |
| CE18 | PET | 158.4 | 15.6 | 38.2 | 22.6 | 39.5 | 12.9 |

As shown in Table 11, the crystallization enthalpies of the hard segment (PET) of the copolyesters of the copolyester compositions of Comparative Examples 15 to 18 are less than 15 J/g whether inorganic and/or organic additives were added or not, and the crystallization enthalpy of the hard segment (PBT) of the copolyester of the copolyester composition of Example 2 is 27.8 J/g, which demonstrates that the strength of the composite fiber made from the copolyester composition of Examples 2 is better than that of the composite fibers made from the copolyester compositions of Comparative Examples 15 to 18.

Furthermore, the melting enthalpies of the soft segments (PEG) of the copolyesters of the copolyester compositions of Comparative Examples 15 to 18 (less than 41 J/g) are less than that of the melting enthalpy of the soft segment of the copolyester of the copolyester composition of Example 2 (48.5 J/g), and the values of ΔT (greater than 22° C.) of Comparative Examples 15 to 18 are greater than that of Example 2 (19.4° C.). This demonstrates that the bidirectional temperature-regulating effect of the composite fiber made from the copolyester composition of Example 2 is better than that of the composite fibers made from the copolyester compositions of Comparative Examples 15 to 18.

In view of the aforesaid, the strength and the bidirectional temperature-regulating effect of the composite fiber can be improved using a copolyester composition in which a copolyester including a hard segment of PBT is included.

### <Comparison and Discussion of Application Example 1 and Comparative Application Examples 1 and 2>

The thermal properties of the composite fibers of Application Example 1 and Comparative Application Examples 1 and 2 as measured using the aforesaid tests are shown in Table 12 below.

TABLE 12

| | | | | | | Melting | |
|---|---|---|---|---|---|---|---|
| | | | Tc of | Tm of | | enthalpy | |
| | | | hard | soft | | of soft | |
| | Core | Sheath | segment | segment | ΔT | segment | Strength |
| | (amount) | (amount) | (° C.) | (° C.) | (° C.) | (J/g) | (g/den) |
| AE1 | E2 | PET | 15.6 | 30.1 | 14.5 | 18.6 | 3.0 |
| | (50 wt %) | (50 wt %) | | | | | |
| CAE1 | CE1 | PET | 11.2 | 32.2 | 21.0 | 10.1 | 2.2 |
| | (50 wt %) | (50 wt %) | | | | | |
| CAE2 | CE12 | PET | N.A. | N.A. | N.A. | N.A. | N.A. |
| | (50 wt %) | (50 wt %) | | | | | |

*N.A. means that data was not available.

As shown in Table 12, the melting enthalpy of the soft segment (PEG) of the copolyester in Comparative Application Example 1, in which neither the inorganic additive nor the aliphatic organic additive was included, is less than that of the soft segment of the copolyester in Application Example 1, in which both the inorganic additive and the aliphatic organic additive were included. The value of ΔT of Application Example 1 is less than that of Comparative Application Example 1, which demonstrates that the bidirectional temperature-regulating effect of the composite fiber of Application Example 1 is better than that of the composite fiber of Comparative Application Example 1.

Furthermore, the strength of the composite fiber of Application Example 1 (3.0 g/den) is greater than that of the composite fiber of Comparative Application Example 1 (2.2 g/den).

This further demonstrates that the bidirectional temperature-regulating effect and the strength of the composite fiber may be improved using the copolyester composition of the disclosure which includes both the inorganic additive and the aliphatic organic additive.

It should be noted that, due to the added amount of the inorganic additive in Comparative Example 12 (1.2 parts by weight based on 100 parts by weight of the copolyester) being greater than that of the inorganic additive in Examples 1 to 16 (0.02 to 1.00 part by weight based on 100 parts by weight of the copolyester), the composite fiber formed form the copolyester composition during the melt-spinning process readily broke, and thus the thermal properties thereof could not be obtained.

### <Comparison and Discussion of Temperature Regulation Factors (TRF) of the Nonwoven Fabrics of Application Example 2 and Comparative Application Example 3>

Each of the nonwoven fabrics of Application Example 2 and Comparative Application Example 3 was tested according to the ASTM D7024-2004 standard method to obtain the temperature regulation factor thereof. The test results are shown in Table 13. It should be noted that, the smaller the value of TRF, the better the bidirectional temperature-regulating effect of the composite fiber.

TABLE 13

| Nonwoven | Composite | Copolyester | |
|---|---|---|---|
| fiber | fiber | composition | TRF |
| AE2 | AE1 | E2 | 0.54 |
| CAE3 | CAE1 | CE1 | 0.82 |

As shown in Table 13, the value of TRF of the nonwoven fabric of Comparative Application Example 3, in which the copolyester composition for producing the nonwoven fabric was free of the organic and inorganic additives, is greater than that of the nonwoven fabric of Application Example 2, in which the copolyester composition for producing the nonwoven fabric included both the inorganic additive and the aliphatic organic additive. This demonstrates that the bidirectional temperature-regulating effect of the composite fiber can be improved using the copolyester composition of the disclosure in which both the inorganic additive and the aliphatic organic additive are included.

In conclusion, since the copolyester composition of the disclosure includes both the inorganic additive and the aliphatic organic additive which has a melting point between a crystallization temperature of the hard segment and a melting point of the soft segment and which has a molecular weight not larger than 1000, the composite fiber made from the copolyester composition of the disclosure has enhanced strength and bidirectional temperature-regulation.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A copolyester composition for forming a temperature-regulating component of a composite fiber, comprising:
a copolyester including a hard segment which includes polybutylene terephthalate, and a soft segment which includes polyethylene glycol and which has a weight average molecular weight ranging from 2500 to 10000;
an inorganic additive; and
an aliphatic organic additive which has a melting point between a crystallization temperature of said hard segment and a melting point of said soft segment, and which has a molecular weight not larger than 1000;
wherein said inorganic additive is in an amount ranging from 0.02 to 1.00 part by weight and said aliphatic organic additive is in an amount ranging from 0.02 to 1.00 part by weight based on 100 parts by weight of said copolyester.

2. The copolyester composition according to claim 1, wherein said soft segment is in a ratio ranging from 30 wt % to 80 wt % based on 100 wt % of said copolyester.

3. The copolyester composition according to claim 1, wherein said soft segment has a weight average molecular weight ranging from 3000 to 9000.

4. The copolyester composition according to claim 3, wherein said soft segment has a weight average molecular weight ranging from 3400 to 8000.

5. The copolyester composition according to claim 1, wherein said aliphatic organic additive is selected from the group consisting of a C₁₃-C₂₈ linear aliphatic hydrocarbon, a C₁₃-C₂₈ linear aliphatic hydrocarbyl ester, a C₁₃-C₂₈ linear aliphatic acid, salts thereof, and combinations thereof.

6. The copolyester composition according to claim 5, wherein said aliphatic organic additive is selected from the group consisting of stearic acid, a salt of stearic acid, tridecyl methacrylate, and combinations thereof.

7. The copolyester composition according to claim 1, wherein the melting point of said aliphatic organic additive ranges from 50° C. to 168° C.

8. The copolyester composition according to claim 7, wherein the melting point of said aliphatic organic additive ranges from 55° C. to 160° C.

9. The copolyester composition according to claim 1, wherein said inorganic additive is selected from the group consisting of talc, mica, zinc oxide, calcium oxide, titanium dioxide, silicon dioxide, calcium carbonate, barium sulfate, magnesium oxide, and combinations thereof.

10. A composite fiber comprising a temperature-regulating component made from the copolyester composition according to claim 1.
